(19) United States
(12) Patent Application Publication
(10) Pub. No.: US 2025/0112014 A1
(43) Pub. Date: Apr. 3, 2025

(54) ADDITIVE MANUFACTURING OF AN ION OPTICAL DEVICE

(71) Applicant: Thermo Finnigan LLC, San Jose, CA (US)

(72) Inventors: Paul Hendricks, San Jose, CA (US); Harald Oser, San Jose, CA (US); Brian Duda, San Jose, CA (US)

(21) Appl. No.: 18/906,049

(22) Filed: Oct. 3, 2024

Related U.S. Application Data
(60) Provisional application No. 63/587,636, filed on Oct. 3, 2023.

(51) Int. Cl. H01J 1/48

(52) U.S. Cl. CPC H01J 1/48

(57) ABSTRACT

A method of manufacturing an ion optical device includes printing the ion optical device in a printing direction from a first end to a second end. The ion optical device includes a first end support at the first end, a first set of rods extending from the first end support and formed with a first set of rings, a second set of rods extending from the first end support and formed with a second set of rings, and a second end support at the second end to which the first and second sets of rods extend. Cutting the first and second end supports away from the ion optical device defines a first electrical circuit through the first set of rods and the first set of rings and a second electrical circuit through the second set of rods and the second set of rings that are electrically isolated from each other.

### CROSS REFERENCE TO RELATED APPLICATION

This application claims the benefit of U.S. Provisional Application No. 63/587,636, filed Oct. 3, 2023, which is incorporated herein in its entirety.

### FIELD

The present disclosure relates to mass spectrometers. More specifically, the present disclosure relates to an additive manufacturing method for manufacturing an ion optical device for use in a mass spectrometer.

### BACKGROUND

Ion optical devices are generally known in the art of mass spectrometers. Ion optical devices generally include an ion guide having a plurality of metal rods arranged symmetrically around a central axis. A voltage is applied to the rods to generate an electric field within a field radius, which is the distance from the central axis to a nearest rod. With the application of voltage, the rods serve as electrodes. The plurality of rods (or electrodes) are separated into two groupings (or pairs). A first pair of electrodes receives a first voltage, while the second pair of electrodes receives a second voltage. The second voltage is an equal magnitude but opposite polarity of the first voltage. The electrodes are arranged around the central axis to alternate between one of the first grouping (or first pair) of electrodes and one of the second grouping (or second pair) of electrodes. Stated another way, each rod (or electrode) alternates around the central axis between the first pair of electrodes and the second pair of electrodes. The alternating voltage of the electrodes generates an electric potential to guide an ion along the ion guide. Known ion optical devices are relatively complex and include a number of auxiliary components to facilitate structural and operational functions of the ion optical device. The rods and the auxiliary components are manufactured utilizing complex methods and assembled using specialized tooling. Further, as sizes of ion optical devices are decreased in size and scale, individual geometries for the associated components become more complex. As such, there is a need to develop improved manufacturing systems to produce ion optical devices.

### SUMMARY

In one example of an embodiment, a method of manufacturing an ion optical device assembly includes printing an ion optical device in a printing direction using additive manufacturing, the ion optical device including a plurality of rods, a plurality of rings coupled to the rods, and an end support coupled to the plurality of rods, the ion optical device defining a central axis, the central axis parallel with the printing direction, finishing a surface of the ion optical device, removing the end supports from the ion optical device, and coupling a shroud to the plurality of rings.

In another example of an embodiment, the printing of the ion optical device is performed with a 3-D printer.

In another example of an embodiment, the method further includes printing a plurality of print supports with the ion optical device using additive manufacturing.

In another example of an embodiment, the method further includes removing the plurality of print supports from the ion optical device after the printing step.

In another example of an embodiment, the method further includes removing the end supports from the ion optical device to create a first electric circuit and a second electric circuit.

In another example of an embodiment, the method further includes printing a plurality of fillets with the ion optical device using additive manufacturing.

In another example of an embodiment, the plurality of rods includes a first plurality of rods and a second plurality of rods, the plurality of rings includes a first ring and a second ring, and the first ring is electrically connected to the first plurality of rods, and the second ring is electrically connected to the second plurality of rods.

In another example of an embodiment, the printing of the ion optical device is performed using metal.

Other aspects of the invention will become apparent by consideration of the detailed description and accompanying drawings.

### BRIEF DESCRIPTION OF THE DRAWINGS

FIG. 1 is a perspective view of an example of an embodiment of an ion guide manufactured using an improved method of manufacturing before end supports are removed.

FIG. 2A is a cross-sectional view of one of the plurality of rings taken along line 2a-2a of FIG. 1 with one of the end supports removed.

FIG. 2B is a cross-sectional view of another of the plurality of rings taken along line 2b-2b of FIG. 1 with the same one of the end supports removed.

FIG. 3 is a perspective view of the ion guide assembly positioned within a mount, the ion guide assembly including the ion guide of FIG. 1 (after the end supports are removed) and shrouds.

FIG. 4 is a schematic diagram of an example of the method of manufacturing the ion guide assembly of FIG. 3.

FIG. 5 is a perspective view of a portion of the ion guide of FIG. 1 during manufacturing, illustrating a plurality of supports between a print bed and one of the plurality of rings, as well as between two of the rings, and depicting imaginary boxes around a ring layer and a rod layer for clarity.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

The present disclosure relates to a method of manufacturing an ion guide for use in an ion optical device of a mass spectrometer. Ion guides are used in mass spectrometers to accelerate ions. Ion guides include two sets of conductive rods equally spaced around a central axis. The first set of rods, also referred to as a first pair of electrodes, is configured to receive a first alternating current having a first voltage. The second set of rods, also referred to as a second pair of electrodes, is configured to receive a second alternating current that has a second voltage equal to the first voltage, but with the opposite polarity. The voltage applied to the respective pairs of rods (or electrodes) alternates between the first and second voltages. The speed of the alternating changes in voltage, or frequency, accelerates the ions along the central axis.

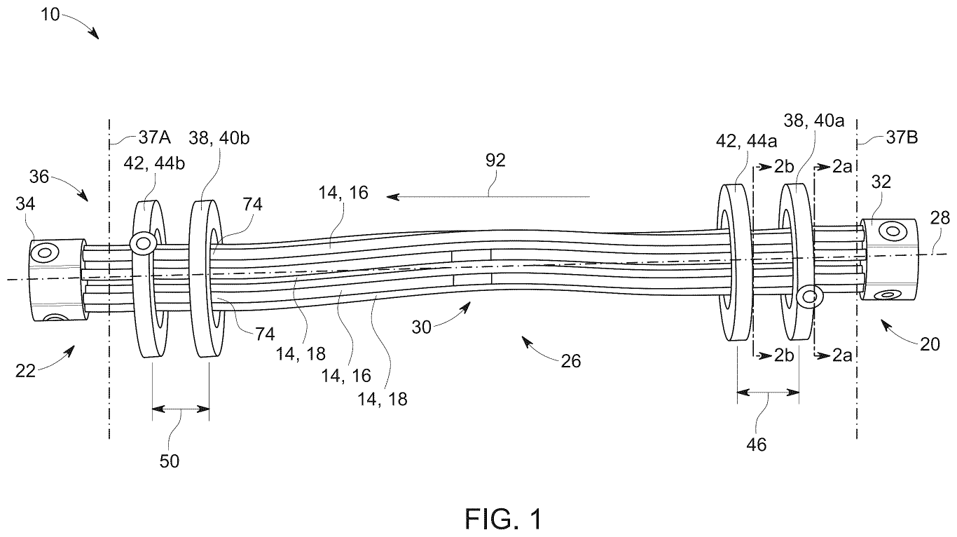

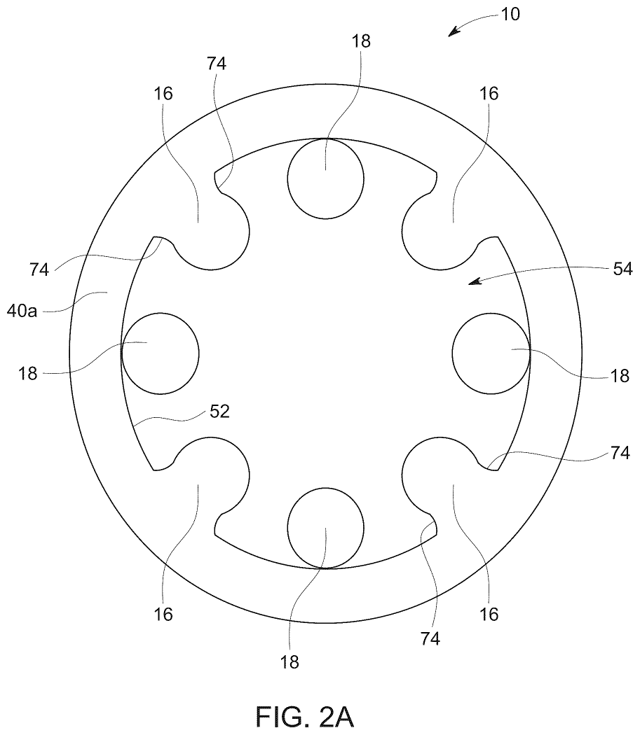

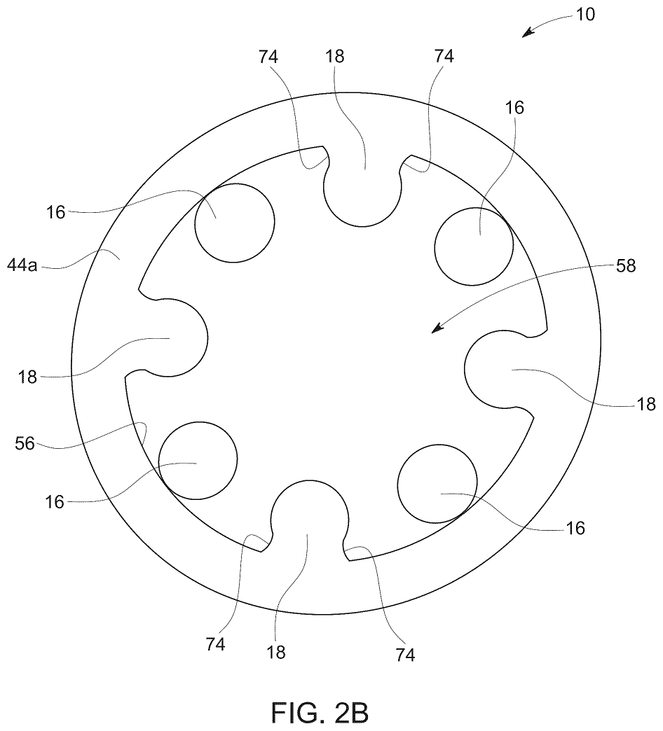

FIG. 1 illustrates an improved ion guide 10 for an ion optical device 10 used in a mass spectrometer (not shown). The ion guide 10 is manufactured using an improved manufacturing process using additive manufacturing (e.g., three-dimensional (3D) printing technology) that includes a plurality of rods 14 (also referred to as a plurality of electrodes 14). The plurality of rods 14 includes a first set of rods 16 (or a first pair of rods 16) and a second set of rods 18 (or a second pair of rods 18), which is discussed in further detail below. Each rod 14 defines a circular cross-sectional shape (as shown in FIGS. 2A and 2B). As such, the illustrated rods 14 are generally cylindrical. In other examples of embodiments, the rods 14 can have any suitable cross-sectional shape (e.g., rectangular, hyperbolic, etc.). In the illustrated embodiment, each rod 14 is solid. However, in other examples of embodiments, each rod 14 can be hollow (or substantially hollow). The rods 14 are formed of a conductive material to conduct electricity. Accordingly, the rods 14 are formed of metal (or a metal alloy), such as titanium, stainless steel, or any other suitable conductive material.

Each rod 14 defines a first end 20, a second end 22 opposite the first end 20, and a central portion 26 positioned between the first and second ends 20, 22. The first and second ends 20, 22 of each rod 14 are aligned with a central axis 28. Stated another way, the first and second ends 20, 22 of each rod 14 are oriented parallel to the central axis 28. The illustrated ion guide 10 includes a bend 30 (or arcuate portion 30) in the central portion 26 of each rod 14. The bends 30 of each rod 14 are aligned, such that each rod 14 maintains an equal radial distance from the central axis 28 through the central portion 26. An ion guide 10 that includes bend 30 in the central portion 26 can be referred to as having a C-trap to facilitate ion injection. In other examples of embodiments, the central portion 26 can be linear (or aligned) with the central axis 28. In these embodiments, each rod 14 is oriented parallel to the central axis 28 along a length of the rod 14. In yet other examples of embodiments, one (or both) of the ends 20, 22 of each rod 14 can be misaligned relative to the central portion 26. As a non-limiting example, the first end 20 can be oriented parallel with the central axis 28, while the second end 22 is oriented at an oblique angle (or perpendicular angle) relative to the central axis 28. In this example, the ion guide 10 can be referred to as a bent flatapole.

With continued reference to FIG. 1, the ion guide 10 includes a first end support 32 and a second end support 34. The first end support 32 is coupled to the first end 20 of the rods 14, while the second end support 34 is coupled to the second end 22 of the rods 14. In the illustrated embodiment, the first and second end supports 32, 34 are integrally formed with the rods 14. The first and second end supports 32, 34 are configured to assist with alignment of the rods 14 during manufacturing. Once manufacturing of the rods 14 is complete, the first and second end supports 32, 34 are configured to be removed from the rods 14, as is described in more detail below.

With continued reference to FIG. 1, the ion guide 10 includes a plurality of rings 36. The rings 36 project radially from the rods 14. The illustrated plurality of rings 36 includes a first set of rings 38 (also referred to as a first pair of rings 38) and a second set of rings 42 (also referred to as a second pair of rings 42). The first set of rings 38 is connected to the first set of rods 16. The first set of rings 38 and the first set of rods 16 form part of a first electrical circuit, which is discussed in further detail below. The second set of rings 42 is connected to the second set of rods 18. The second set of rings 42 and the second set of rods 18 form part of a second electrical circuit, which is also discussed in further detail below. The illustrated first set of rings 38 includes a first ring 40a and a second ring 40b. In other examples of embodiments, the first set of rings 38 can include a single ring or three or more rings. The illustrated second set of rings 42 includes a third ring 44a and a fourth ring 44b. In other examples of embodiments, the second set of rings 42 can include a single ring or three or more rings.

With continued reference to FIG. 1, the first and third rings 40a, 44a are positioned near the first end 20. The first ring 40a is positioned between the first end 20 and the third ring 44a. The first and third rings 40a, 44a are spaced apart by a first distance 46. The second and fourth rings 40b, 44b are positioned near the second end 22. The fourth ring 44b is positioned between the second ring 40b and the second end 22. The second and fourth rings 40b, 44b are spaced apart by a second distance 50. The illustrated first and second distances 46, 50 are equal. In other examples of embodiments, the first and second distances 46, 50 can be different. In addition, the first and second distances 46, 50 can be any suitable or desired distance between the associated rings 40a, 44a and 40b, 44b.

With reference to FIGS. 2A and 2B, each of the first and second sets of rods 16, 18 includes N number of rods 14. N can be any suitable integer. In the illustrated embodiment, N equals four, such that each set of rods 16, 18 includes four rods 14. Accordingly, the illustrated ion guide 10 includes a total of eight rods 14. The ion guide 10 with eight total rods 14 can also be referred to as an octupole 10, as the ion guide 10 includes four rods 14 in the first set of rods 16, and four rods 14 in the second set of rods 18. In other examples of embodiments, the ion guide 10 can generically be referred to as a multipole ion guide 10, as a multipole defines N number of first rods 16 (or first pair of electrodes 16) and N number of second rods 18 (or second pair of electrodes 18). In one example, N can equal two such that the ion guide 10 includes four total rods 14 to form a quadrupole.

Each ring 36 is coupled to one of the sets of rods 16, 18. More specifically, each ring 36 is integrally formed with one of the sets of rods 16, 18. With reference to FIG. 2A, the first set of rods 16 is coupled to a first inner surface 52 of the first ring 40a. More specifically, the first set of rods 16 is integrally formed with the first inner surface 52 of the first ring 40a. The second set of rods 18 is separated from the first ring 40a. Stated another way, the second set of rods 18 is electrically independent of the first ring 40a. The first inner surface 52 defines a circumference of a first central aperture 54 of the first ring 40a. The second rods 18 are positioned in the first central aperture 54. The second rods 18 can be spaced apart from the first inner surface 52. Stated another way, a gap can be positioned between each of the second rods 18 and the first inner surface 52. The illustrated first and second rings 40a, 40b are substantially identical. While not illustrated, the second ring 40b includes the same features as the first ring 40a described herein.

With reference back to FIG. 1, the first set of rods 16 is coupled to the first ring 40a and the second ring 40b. More specifically, the first set of rods 16, the first ring 40a, and the second ring 40b are integrally formed. As the ion guide 10 is composed of a conductive material, the first set of rods 16, the first ring 40a, and the second ring 40b are electrically connected.

With reference to FIG. 2B, the second set of rods 18 is coupled to a third inner surface 56 of the third ring 44a. More specifically, the second set of rods 18 is integrally formed with the third inner surface 56 of the third ring 44a. The first set of rods 16 is separated from the third ring 44a. Stated another way, the first set of rods 16 is electrically independent of the third ring 44a. The third inner surface 56 defines a third central aperture 58. The first rods 16 are positioned in the third central aperture 58. The first rods 16 can be spaced apart from the third inner surface 56. Stated another way, a gap can be positioned between each of the first rods 16 and the third inner surface 56. The illustrated third and fourth rings 44a, 44b are substantially identical. While not illustrated, the fourth ring 44b includes the same features as the third ring 44a described herein.

With reference back to FIG. 1, the second set of rods 18 is coupled to the third ring 44a and the fourth ring 44b. More specifically, the second set of rods 18, the third ring 44a, and the fourth ring 44b are integrally formed. As the ion guide is composed of a conductive material, the second set of rods 18, the third ring 44a, and the fourth ring 44b are electrically connected.

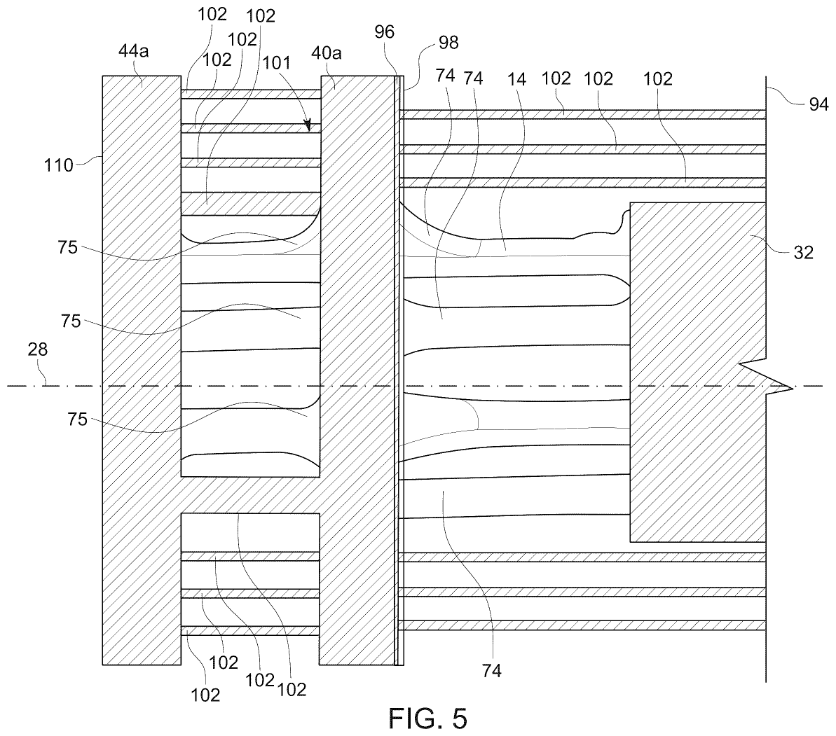

With reference back to FIGS. 2A and 2B, the ion guide 10 can include a plurality of fillets 74. As illustrated in FIG. 2A, fillets 74 are formed between each first rod 16 and the first inner surface 52. As illustrated in FIG. 2B, the fillets 74 are formed between each second rod 18 and the third inner surface 56. Each illustrated fillet 74 defines an arcuate surface. The arcuate surfaces can have any desired radius. The radius of the arcuate surface can be adjusted to achieve a desired cross-sectional area of the ion guide 10. Accordingly, the fillets 74 can improve the structural rigidity of the ion guide 10 by reinforcing a connection between the respective rod 16, 18 and the associated ring 40a, 44a. Additionally, or alternatively, the fillets 74 can improve the electrical conductivity of the ion guide 10 by facilitating improved electrical flow between the respective rod 16, 18 and the associated ring 40a, 44a. The fillets 74 are discussed in more detail below in connection with FIG. 5.

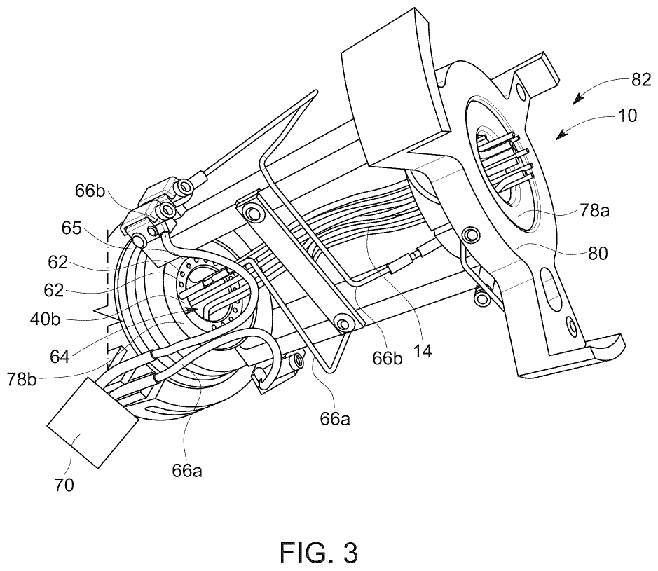

With reference to FIG. 3, the second ring 40b can include a plurality of ring apertures 62 positioned on a side surface of the second ring 40b. The ring apertures 62 can be oriented to be parallel to a second central aperture 64. The second central aperture 64 is defined by a second inner surface 65 of the second ring 40b. In the illustrated embodiment, the ring apertures 62 are triangular in shape. In other examples of embodiments, the ring apertures 62 can have any suitable or desired shape (e.g., circular, rectangular, etc.). In yet other examples of embodiments, the second ring 40b does not include any ring apertures 62. The ring apertures 62 can reduce the amount of metal material in the second ring 40b, reducing a weight of the second ring 40b. Accordingly, the ring apertures 62 can function as a material and weight saving feature of the ion guide 10. While not illustrated, the first, third, and fourth rings 40a, 44a, 44b can also include ring apertures substantially identical to the ring apertures 62.

The ring apertures 62 can also facilitate an electrical connection between the ion guide 10 and an electricity source 70 (or an alternating current (AC) source or radio frequency (RF) source). In the illustrated embodiment, a first port of the electricity source 70 is connected to a first electrical connector 66a. A second port of the electricity source 70 is connected to a second electrical connector 66b. The first electrical connector 66a is coupled to one of the ring apertures 62 in the second ring 40b. Together, the first set of rods 16, the first ring 40a, the second ring 40b, the first electrical connector 66a, and the electricity source 70 define the first electrical circuit. The electricity source 70 can provide a flow of electrons through the first electrical circuit. The second electrical connector 66b is coupled to the third ring 44a (not shown). The second electrical connector 66b can be coupled to the third ring 44a by, for example, ring apertures in the third ring 44a. Together, the second set of rods 18, the third ring 44a, the fourth ring 44b, the second electrical connector 66b, and the electricity source 70 define the second electrical circuit.

In the illustrated embodiment, the first and second electrical circuits are independent. Stated another way, a first flow of electricity flows through the first electrical circuit, and a second flow of electricity flow through the second electrical circuit. The illustrated electricity source 70 includes the first and second ports, which allow the first and second electrical circuits to receive independent flows of electricity from one electricity source 70. In other embodiments, a first electricity source may replace the first port of the electricity source 70 and provide a first flow of electricity to the first electrical circuit. In these embodiments, a second electricity source may replace the second port of the electricity source 70 and provide a second flow of electricity to the second electrical circuit.

With continued reference to FIG. 3, a first shroud 78a and a second shroud 78b are coupled to the ion guide 10. The first shroud 78a surrounds an outer circumference of the first and third rings 40a, 44a. The second shroud 78b surrounds an outer circumference of the second and fourth rings 40b, 44b. The first and second shrouds 78a, 78b are composed of an insulative material. The insulative material can be, but is not limited to, polyether ether ketone (PEEK).

The ion guide 10 and the shrouds 78a, 78b are received in a mount 80. Specifically, the mount 80 receives each shroud 78a, 78b. The mount 80 is composed of a rigid material. The mount 80 can include brackets, such as for securing the first and second electrical connectors 66a, 66b to the mount 80. The ion guide 10, the electrical connectors 66a, 66b, the electricity source 70, the shrouds 78a, 78b, and the mount 80 define an ion guide assembly 82 (also referred to as an ion optical device assembly 82).

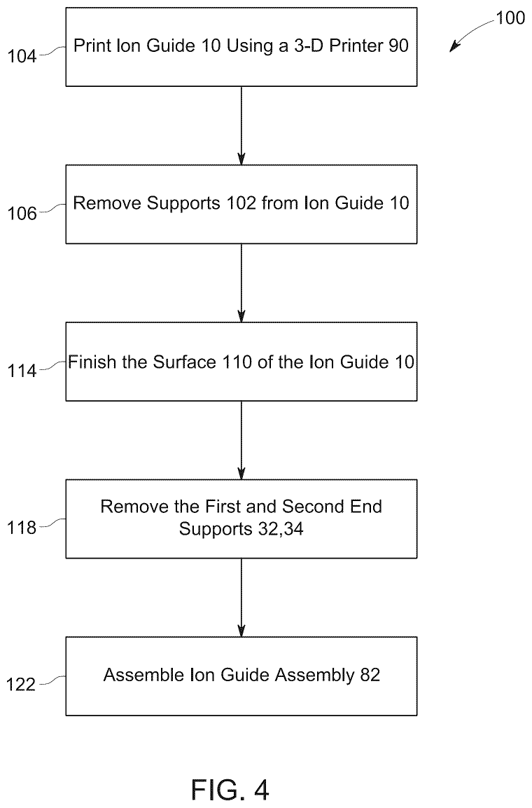

With reference now to FIG. 4, a process 100 of manufacturing an ion guide (such as the ion guide 10) is illustrated. The process 100 facilitates manufacturing of the ion guide assembly 82. The process of manufacturing 100 includes a plurality of instructions or steps that are depicted in flow diagram form. The process begins at step 104, where the ion guide 10 is manufactured using an additive manufacturing process. In one non-limiting example, the ion guide 10 is manufactured using a 3-D printer 90. The 3-D printer 90 uses a metal or a conductive material (e.g., titanium, stainless steel, etc.) as the printing material. The 3-D printer 90 prints the ion guide 10 in a plurality of layers. Each layer has a predetermined thickness (or resolution). The thickness of each layer is inversely correlated to the quality (i.e., the accuracy, the surface finish, etc.) of the printed ion guide 10. Stated another way, the smaller the thickness of each layer, the greater the quality of the printed ion guide 10.

During printing, the printed layers are stacked along a manufacturing direction 92 (also referred to as a printing direction 92) (shown in FIG. 1). A first layer is printed on a print bed 94 (shown in FIG. 5). A second layer is then printed on top of the first layer. This sequence is repeated with new layers throughout the duration of the printing process. The illustrated printing direction 92 is oriented such that the printing occurs from the first end 20 to the second end 22. For example, the first end 20 is printed first with the first end support 32, followed by the rods 14 alone or in combination with the first ring 40a, the third ring 44a, the central portion 26, the second ring 40b, and the fourth ring 44b, before reaching the second end support 34 at the second end 22. In the illustrated embodiment, the printing direction 92 is aligned with the central axis 28. More specifically, the printing direction 92 is parallel with the central axis 28. By orienting the printing direction 92 parallel with the central axis 28, the print quality is unexpectedly improved because the cross-section of each new layer is substantially similar to the cross-section of the previous layer. As such, every new layer will be supported by the previous layer. In other examples of embodiments, the printing direction 92 can be oriented oblique relative to the central axis 28 to maximize the quality of the printed ion guide 10. Further information regarding improvements to print quality are provided below.

In addition, the printing direction 92 may be oriented vertically, horizontally or in another direction between the horizontal and vertical directions. In the illustrated examples, unexpectedly improved results were obtained with the printing direction oriented substantially in the vertical direction. Thus, in conjunction with the observation above, unexpectedly improved results were obtained when the printing direction 92 was both parallel to the central axis 28 and oriented vertically.

During printing, the shape of the ion guide 10 can cause challenges. Specifically, a change in cross-section between adjacent layers can cause quality deficiencies during printing. As a nonlimiting example, and with reference to FIG. 5, the 3-D printer 90 prints a ring layer 96 (also referred to as a first ring layer 96) of the first ring 40a. The ring layer 96 is the first printed layer to include the first ring 40a. The ring layer 96 defines a cross-section including the rods 14 and the first ring 40a. The ring layer 96 is positioned upon a rod layer 98 such that the rod layer 98 is the layer adjacent the ring layer 96. The rod layer 98 defines a cross-section that includes the rods 14. As such, the ring layer 96 has a greater cross-sectional area than the rod layer 98. Imaginary boxes are illustrated in FIG. 5 around the ring and rod layers 96, 98 for clarity. It should be appreciated that the imaginary boxes do not represent the thickness of the ring and/or rod layers 96, 98. The ring layer 96 includes a cantilevered portion 101 that is cantilevered off the rod layer 98 in a radial direction (i.e., a direction generally perpendicular to the central axis 28). The ring layer 96, specifically the cantilevered portion 101, can lack sufficient support to be printed accurately. For example, an undesirable print can occur in which the cantilevered portion 101 bends toward the print bed 94 under the weight of the material. This undesirable bend can persist throughout the remaining layers of the first ring 40a. To assist with avoiding this issue, and to further support the ring layer 96, a plurality of supports 102 (also referred to as a plurality of print supports 102) can be used. The illustrated supports 102 are positioned between and coupled to the print bed 94 and the ring layer 96 of the first ring 40a. More specifically, the supports 102 are integrally formed with the ring layer 96 of the first ring 40a. The supports 102 can be positioned in desired positions to support specific areas. For example, the illustrated supports 102 provide support to the cantilevered portion 101. The supports 102 temporarily increase the cross-sectional area of the rod layer 98. The number and the size of the supports 102 can be adjusted to achieve a desired cross-section of the rod layer 98. Ultimately, the supports 102 create a more gradual change in cross-sectional area between the rod layer 98 and the ring layer 96. In other examples of embodiments, the supports 102 can also or alternatively be positioned in other locations (e.g., between the first and third rings 40a, 44a, between the second and fourth rings 40b, 44b, etc.). The illustrated supports 102 are columns. In other examples of embodiments, the supports 102 can have a different shape or lattice (e.g., cross-hatched grid, concentric shapes, zig-zag, etc.).

In addition, the fillets 74 on the rods 14 can be formed to extend longitudinally, i.e., parallel to the printing direction, to selected lengths, in addition to extending radially and circumferentially as described above in connection with FIGS. 2A and 2B. Because the fillets 14 can be formed to extend longitudinally, they assist in supporting the structure, particularly at transitions, e.g., where the rods 14 are joined to the rings 36, 38. For example, the fillet 74 on the uppermost rod 14 visible in FIG. 5 has a truss-like shape in cross section with a large supporting surface adjacent the first ring 40a that tapers over a length of the fillet 74 (i.e., from left to right in the figure) until it blends into the circumference of the uppermost rod 14. Similarly, there can also be fillets 75 formed at the junctions on the upper sides of structure at transitions, such as is shown in FIG. 5 for an upper side of the first ring 40a. The fillet 75 for the uppermost rod is largest where the uppermost rod 14 protrudes above the first ring 40a and tapers in size over a selected length (from right to left) until it blends into the circumference of the uppermost rod 14. The fillet 75 can be smaller than the fillet 74 as is illustrated in FIG. 5, e.g., because the load to be supported by the fillet 75 at the upper side of the first ring 40a is less than the load to be supported by the fillet 74 at the lower side of the first ring 40a (especially if the ion guide is being formed vertically). In other examples, the relative sizes of the fillets 74 and 75 may be reversed, or they may be approximately the same in size.

With returned reference to FIG. 4, at step 106 the supports 102 are removed from the ion guide 10. Rough or jagged spots (not shown) can be left on a surface 110 of the ion guide 10 at the locations where the removed supports 102 were connected to the ion guide 10. In addition to the rough or jagged spots, the surface 110 can also (or alternatively) include imperfections due to printing. In one non-limiting example, the surface 110 can include undulations caused by adjacent layers of material (not shown).

At step 114 the surface 110 of the ion guide 10 can be finished to achieve a desired property or properties (e.g., appearance, electrical conductivity, etc.). The surface 110 can be finished by any methodology, such as, but not limited to, isotropic superfinishing, grinding, sanding, polishing, and/or chemical treatment. In some examples of embodiments, step 114 can include multiple methods of surface finishing.

At step 118, the end supports 32, 34 are removed from the ion guide 10. In the illustrated embodiment, once the end supports 32, 34 are removed, the first electrical circuit and the second electrical circuit are independent. More specifically, a portion of the first electrical circuit including the first set of rods 16, the first ring 40a, and the second ring 40b is independent from a portion of the second electrical circuit including the second set of rods 18, the third ring 44a, and the fourth ring 44b. In other words, the first and second electrical circuits are not physically nor electrically connected. As such, an electrical current can pass through the first electrical circuit without passing through the second electrical circuit.

Each of the end supports 32, 34 is removed from the remainder of the ion guide 10 by a suitable operation, such as a precision cutting operation. In the illustrated embodiments, the precision cutting operations are carried out at locations on the rods 14 near the end supports 32, 34, respectively, such as at the representative cut lines 37A and 37B shown in FIG. 1. Thus, the cut lines 37A, 37B define the ends of the completed ion guide 10. The cut lines 37A, 37B are typically oriented exactly perpendicular to the central axis 28. The cut lines 37A, 37B are typically positioned so that the resulting ends of the completed ion guide 10 are symmetrical. If necessary, finishing of the areas adjacent one or both of the cut lines 37A, 37B can be completed. For the example of the ion guide 10, after cutting operations at both the cut lines 37A, 37B are completed, then the ion guide being produced is converted from a single-piece intermediate structure into the two-piece final structure, where the two pieces are physically and electrically separated from each other.

Having the ion guide formed as a single-piece intermediate structure before it is ultimately separated into two or more pieces has a number of benefits. First, forming the ion guide as a single-piece intermediate structure allows for achieving tighter dimensional and positional tolerances. In some example embodiments, specified dimensions and/or positions were achieved within 200-250 microns, which is considered highly precise and contributes to improved function of the ion guide. Also, the single-piece intermediate structure could be positioned and manipulated more easily and without requiring specially designed holding devices and/or jigs. This is especially true for the illustrated examples of the ion guide 10 in which the rods 14 have bends or curves that would be difficult to hold for precise positioning relative to each other if they were provided in multiple pieces.

At step 122, the first shroud 78a is positioned over the first and third rings 40a, 44a and the second shroud 78b is positioned over the second and fourth rings 40b, 44b. The shrouds 78a, 78b can secure the first and second electrical circuits such that the first and second electrical circuits are neither physically nor electrically connected. The ion guide assembly 82 can be inserted into the mount 80 (shown in FIG. 3), and the electricity source 70 can be connected. One or more additional components can be attached or otherwise connected to complete the ion guide assembly 82. Once complete, the ion guide assembly 82 can then be installed and used in a mass spectrometer (not shown).

Although the invention has been described in detail with reference to certain preferred embodiments, variations and modifications exist within the scope and spirit of one or more independent aspects of the invention as described. Various features and advantages of the invention are set forth in the following claims.

We claim:

1. A method of manufacturing an ion optical device, the method comprising:
printing the ion optical device in a printing direction from a first end to a second end, including a first end support at the first end, a first set of rods extending from the first end support and formed with a first set of rings, a second set of rods extending from the first end support and formed with a second set of rings, and a second end support at the second end to which the first and second sets of rods extend; and
cutting the first and second end supports away from the ion optical device to thereby define a first electrical circuit through the first set of rods and the first set of rings and a second electrical circuit through the second set of rods and the second set of rings, wherein the first electrical circuit and the second electrical circuit are electrically isolated from each other.

2. The method of claim 1, further comprising finishing a surface of the ion optical device following the printing of the ion optical device.

3. The method of claim 1, wherein the first and second sets of rods extend through openings in the first and second sets of rings, respectively.

4. The method of claim 1, wherein printing the ion device comprises forming print supports by printing to support cantilevered portions of the first set of rings and the second set of rings.

5. The method of claim 4, wherein the first set of rings comprises a first ring and a second ring and the second set of rings comprises a third ring and a fourth ring, and wherein the print supports are formed to extend between the first ring and the third ring and between the second ring and the fourth ring.

6. The method of claim 4, further comprising removing the print supports from the ion optical device after the printing step.

7. The method of claim 1, wherein positions of the first set of rods relative to positions of the second set of rods are within a tolerance range not exceeding 250 microns.

8. The method of claim 1, wherein the ion optical device has a central axis, and wherein the printing direction and the central axis are oriented substantially vertically.

9. The method of claim 1, wherein the first set of rods is joined to the first set of rings with first fillets extending at least radially and circumferentially from the first set of rods, and the second set of rods is joined to the second set of rings with second fillets extending at least radially and circumferentially from the second set of rods.

10. The method of claim 9, wherein the first fillets and second fillets extend longitudinally and have truss-shaped cross-sections tapering from a larger end adjacent a ring surface to a smaller end that joins a circumference of a respective rod surface.

11. An ion optical device formed by additive manufacturing, comprising:
a printed body having a first end support, a second end support, a first set of rods extending from the first end support to the second end support, a first set of rings formed with the first set of rods, a second set of rods extending from the first end support to the second end support, and a second set of rings formed with the second set of rods; and
first and second electrical circuits that are electrically isolated from each other, the first electrical circuit comprising the first set of rods and the first set of rings and the second electrical circuit comprising the second set of rods and the second set of rings, wherein the first and second electrical circuits are formed by cutting away the first and second end supports to separate the first set of rods and the second set of rods from each other.

12. The ion optical device of claim 11, wherein the printed body is formed with a 3-D printer.

13. The ion optical device of claim 11, wherein the printed body is formed with a 3-D printer that prints a metal printing material.

14. A method of manufacturing an ion optical device assembly, the method comprising:
printing an ion optical device in a printing direction using additive manufacturing, the ion optical device including a plurality of rods, a plurality of rings coupled to the rods, and an end support coupled to the plurality of rods, the ion optical device defining a central axis, the central axis parallel with the printing direction;
finishing a surface of the ion optical device;
removing the end support from the ion optical device; and
coupling a shroud to the plurality of rings.

15. The method of claim 14, wherein the printing of the ion optical device is accomplished with a 3-D printer.

16. The method of claim 15, wherein the printing of the ion optical device comprises using a printing material that comprises metal.

17. The method of claim 14, further comprising printing a plurality of print supports formed with the ion optical device using additive manufacturing.

18. The method of claim 17, further comprising removing the plurality of print supports from the ion optical device after the printing step.

19. The method of claim 14, further comprising removing the end supports from the ion optical device to create a first electric circuit and a second electric circuit, the first and second electric circuits being isolated.

20. The method of claim 14, further comprising printing a plurality of fillets with the ion optical device using additive manufacturing.

21. The method of claim 14, wherein the plurality of rods includes a first plurality of rods and a second plurality of rods, the plurality of rings includes a first ring and a second ring, the first ring is electrically connected to the first plurality of rods, and the second ring is electrically connected to the second plurality of rods.
